(19) United States
(12) Patent Application Publication
(10) Pub. No.: US 2020/0159199 A1
(43) Pub. Date: May 21, 2020

(54) SERVER APPARATUS AND INFORMATION PROVIDING METHOD

(71) Applicant: TOYOTA JIDOSHA KABUSHIKI KAISHA, Toyota-shi (JP)

(72) Inventors: Ryota Osumi, Nagoya-shi (JP); Hiroyuki Nakajima, Nagoya-shi (JP); Daijiro Moriwaki, Nagoya-shi (JP); Toshiomi Yamada, Nagoya-shi (JP)

(73) Assignee: TOYOTA JIDOSHA KABUSHIKI KAISHA, Toyota-shi (JP)

(21) Appl. No.: 16/655,416

(22) Filed: Oct. 17, 2019

(30) Foreign Application Priority Data
Nov. 16, 2018 (JP) 2018-215944

(51) Int. Cl. G05B 23/02; G07C 5/00; G07C 5/08; B60W 40/09

(52) U.S. Cl. CPC G05B 23/024; G05B 23/0232; G07C 5/008; B60W 40/09; G07C 5/0841; G07C 5/0816; G07C 5/0808

(57) ABSTRACT

A server apparatus includes circuitry configured to: acquire identification information of an assessment target vehicle from an external server of an assessor; acquire history information of the assessment target vehicle based on the identification information; acquire pieces of history information of a plurality of vehicles; derive statistical information on the pieces of history information for each of vehicle models; and provide first provision information based on the history information of the assessment target vehicle and second provision information based on the statistical information regarding a vehicle model of the assessment target vehicle, to the external server.

### INCORPORATION BY REFERENCE

The disclosure of Japanese Patent Application No. 2018-215944 filed on Nov. 16, 2018 including the specification, drawings and abstract is incorporated herein by reference in its entirety.

### BACKGROUND

### 1. Technical Field

The present disclosure relates to a server apparatus and an information providing method.

### 2. Description of Related Art

Japanese Unexamined Patent Application Publication No. 2015-64616 (JP 2015-64616 A) discloses a vehicle assessment support device which specifies a standard price of an assessment target vehicle, calculates an added value or a reduced value specific to the assessment target vehicle for the standard price based on actual vehicle status information indicating a status of an actual vehicle, and calculates an assessment value of the assessment target vehicle based on the standard price and the added value or the reduced value.

### SUMMARY

In the technique disclosed in JP 2015-64616 A, an assessment value is calculated without taking into consideration information that is difficult to recognize from exterior check or inspection of a vehicle, such as how a vehicle has been treated. Thus, even though a vehicle has been treated with care and is thus in good condition, this may not be reflected in an assessment value.

The disclosure provides a server apparatus and an information providing method, which can provide information that can improve accuracy of an appraised value.

A first aspect of the disclosure provides a server apparatus including circuitry configured to: acquire identification information of an assessment target vehicle from an external server of an assessor; acquire history information of the assessment target vehicle based on the identification information; acquire pieces of history information of a plurality of vehicles; derive statistical information on the pieces of history information for each of vehicle models; and provide first provision information based on the history information of the assessment target vehicle and second provision information based on the statistical information regarding a vehicle model of the assessment target vehicle, to the external server.

According to the first aspect, the first provision information based on history information of an assessment target vehicle and the second provision information based on statistical information regarding a vehicle model of the assessment target vehicle are provided to the external server, and thus it is possible to provide provision information enabling the accuracy of an assessment value to be increased.

In the first aspect, the circuitry may be configured to periodically provide the second provision information based on the statistical information regarding each of the vehicle models to the external server.

A second aspect of the disclosure provides an information providing method including: acquiring identification information of an assessment target vehicle from an external server of an assessor; acquiring history information of the assessment target vehicle based on the identification information; acquiring pieces of history information of a plurality of vehicles; deriving statistical information regarding the pieces of history information of the vehicles, for each of vehicle models; and providing first provision information based on the history information of the assessment target vehicle and second provision information based on the statistical information regarding a vehicle model of the assessment target vehicle, to the external server.

According to the aspects of the present disclosure, it is possible to provide provision information enabling the accuracy of an assessment value to be increased.

### BRIEF DESCRIPTION OF THE DRAWINGS

Features, advantages, and technical and industrial significance of exemplary embodiments of the disclosure will be described below with reference to the accompanying drawings, in which like numerals denote like elements, and wherein:

FIG. 1 is a diagram illustrating a configuration of an information processing system according to a first embodiment;

FIG. 2 is a diagram illustrating a flow of data in the information processing system in FIG. 1;

FIG. 3 is a block diagram illustrating a configuration of a first server apparatus in FIG. 1;

FIG. 4 is a diagram illustrating a display example of a vehicle chart of a vehicle of which a vehicle type is a hybrid car, created by the first server apparatus in FIG. 1;

FIG. 5 is a diagram illustrating a display example of a vehicle chart of a vehicle of which a vehicle type is a gasoline car, created by the first server apparatus in FIG. 1;

FIG. 6 is a diagram illustrating a display example of a vehicle chart of a vehicle of which a vehicle type is an electric vehicle (EV) or a fuel cell vehicle (FCV), created by the first server apparatus in FIG. 1;

FIG. 7 is a flowchart illustrating a process in the first server apparatus in FIG. 1;

FIG. 8 is a diagram illustrating a flow of data in an information processing system according to a fourth embodiment;

FIG. 9 is a diagram illustrating a flow of data in an information processing system according to a sixth embodiment; and

FIG. 10 is a diagram illustrating a flow of data in an information processing system according to an eighth embodiment.

### DETAILED DESCRIPTION OF EMBODIMENTS

### First Embodiment

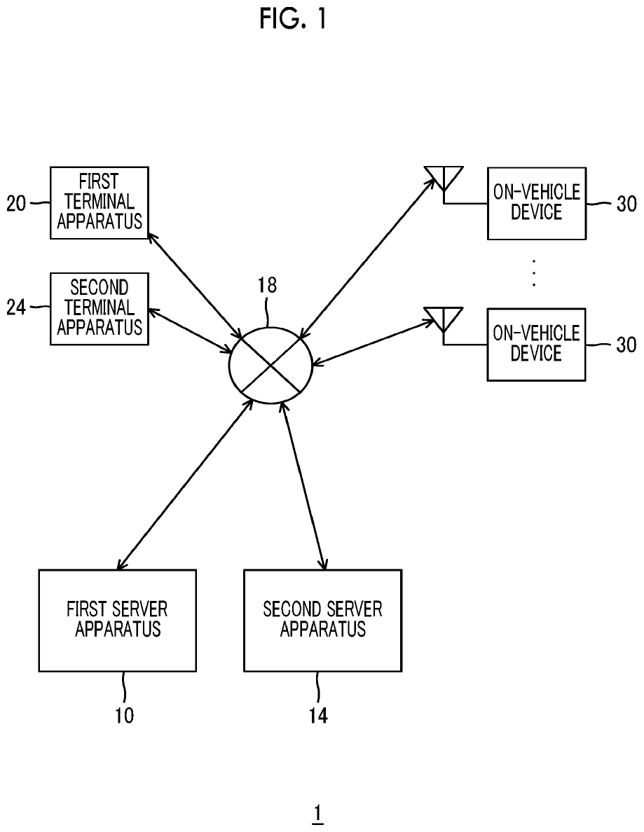

FIG. 1 illustrates a configuration of an information processing system 1 according to a first embodiment. The information processing system 1 is a used-car transaction support system which supports transaction during transaction of a vehicle as a used car by using history information of the vehicle collected from the vehicle, and is used for assessment of a vehicle, for example.

The information processing system 1 includes a first server apparatus 10, a second server apparatus 14, a first terminal apparatus 20, a second terminal apparatus 24, and a plurality of on-vehicle devices 30.

Each of the on-vehicle devices 30 has a wireless communication function, and is connected to a network 18 via a wireless base station or a wireless access point. Each of the second server apparatus 14, the first terminal apparatus 20, and the second terminal apparatus 24 is connected to the network 18 through wired communication or wireless communication. The network 18 is connected to the first server apparatus 10, and the first server apparatus 10 can perform communication with the first server apparatus 10, the second server apparatus 14, the first terminal apparatus 20, the second terminal apparatus 24, and the on-vehicle devices 30 via the network 18.

Each of the first server apparatus 10 and the second server apparatus 14 may be formed by either a single server or a plurality of servers that can communicate with each other. Each of the first server apparatus 10 and the second server apparatus 14 may be formed by an electronic circuit including one or more memories and one or more processing devices. The memory is, e.g., a semiconductor memory, a magnetic memory, or an optical memory, and the processing device is, e.g., a processor.

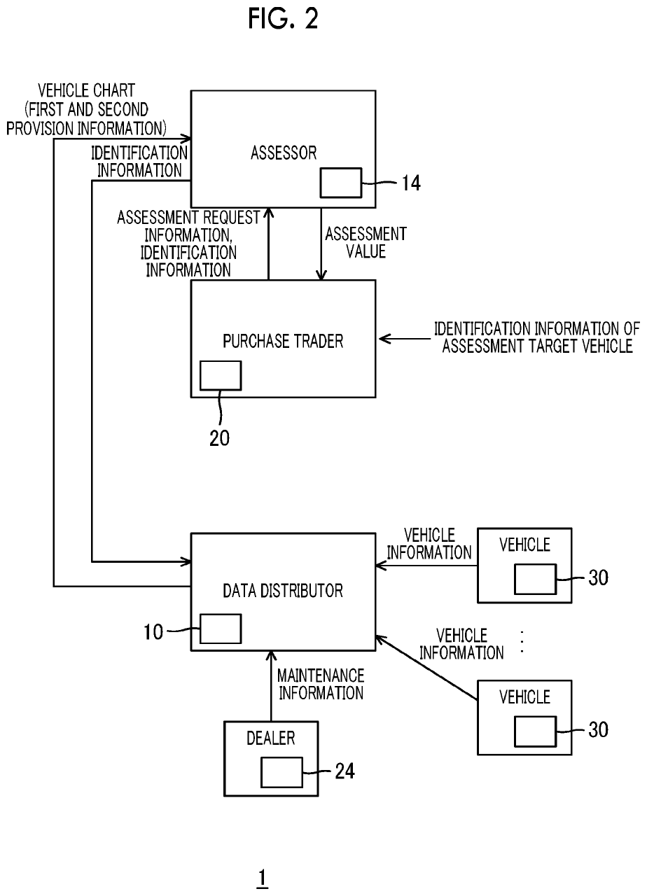

FIG. 2 illustrates a flow of data in the information processing system 1 in FIG. 1. The first server apparatus 10 is provided in a data center of a data distributor. The data distributor may be a car maker. The second server apparatus 14 is managed by a company specialized in vehicle inspection, a residual value calculation company, or the like that is an assessor of a vehicle price.

The first terminal apparatus 20 is used by vehicle purchase traders such as a used-car purchase trader, a vehicle dealer, a lease company, and a rental car company. A purchase trader purchases a vehicle from a user.

The second terminal apparatus 24 is provided in a facility such as a dealer or a maintenance factory in which maintenance or repair of a vehicle is performed. The on-vehicle devices 30 are mounted on a vehicle which is an automobile.

Although not illustrated, there may be a plurality of assessors, purchase traders, and dealers, and the second server apparatus 14, the first terminal apparatus 20, and the second terminal apparatus 24 may be provided in a plurality.

The on-vehicle device 30 periodically acquires vehicle information of a host vehicle, and periodically transmits the vehicle information to the first server apparatus 10. The vehicle information is attached with the acquisition date and time. The vehicle information is also referred to as CAN data, and includes information such as a speed, acceleration in the front-rear direction, acceleration in the leftward-rightward direction, deceleration, an accelerator operation amount, a brake operation amount, a steering-wheel steering angle, a fuel consumption amount per unit time, an economy mode selection state, an odometer value, safety equipment operation information, various sensor values regarding an engine, and various sensor values regarding a drive battery (lithium ion secondary battery). The economy mode represents a mode placing importance on fuel efficiency through traveling in which an engine speed is restricted to be lower than in a standard mode.

The on-vehicle device 30 transmits an abnormality of an on-vehicle system detected by a failure diagnosis device (not illustrated) of the host vehicle to the first server apparatus 10 as vehicle diagnosis information. The vehicle diagnosis information is also included in the vehicle information. The function is referred to as a remote diagnosis function. Examples of the abnormality of the on-vehicle system may include disconnection of various lamps and failures of various sensors, and, in a case where an abnormality occurs in the on-vehicle system, a warning lamp is lighted.

A frequency of acquiring the vehicle information may be set as appropriate through a test or the like, and may be once every several minutes. A frequency of transmitting the vehicle information may be set as appropriate through a test or the like, and may be the same as a frequency of acquiring the vehicle information. The transmitted vehicle information is attached with identification information for identifying a vehicle. The identification information is, for example, a vehicle identification number (VIN).

In a case where maintenance of a vehicle is performed by a dealer or the like, the second terminal apparatus 24 receives input of information regarding the maintenance of the vehicle from an employee or the like, and transmits the maintenance information to the first server apparatus 10. The maintenance information includes replacement information and replacement date-and-time information of parts such as a battery, a lamp, and an oil filter replaced through maintenance of the vehicle, and replacement information and replacement date and time of fluid such as engine oil and a brake fluid. The maintenance information is attached with the identification information of the vehicle.

In a case where a used car is sold to a new owner by a dealer or a used-car purchase trader, the first terminal apparatus 20 or the second terminal apparatus 24 receives input of owner change information regarding the vehicle from an employee or the like, and transmits the received owner change information to the first server apparatus 10. The owner change information includes an owner's attribute indicating an individual or a juridical person, information regarding an owner change time, and the like. The owner change information is attached with identification information of the vehicle.

When a purchase trader purchases a vehicle, the purchase trader acquires, from an original owner of the vehicle, declaration information including information such as the presence or absence of accident history, the presence or absence of submersion history, and the presence or absence of recall non-response. The first terminal apparatus 20 transmits the declaration information regarding the vehicle to the first server apparatus 10. The declaration information is attached with identification information of the vehicle.

The vehicle information, the maintenance information, the owner change information, and the declaration information will be collectively referred to as history information. The vehicle information and the maintenance information may be associated with each other based on date-and-time information.

The first server apparatus 10 of a data distributor periodically acquires pieces of history information of a plurality of vehicles from the on-vehicle devices 30 of the vehicles, and accumulates the acquired history information for each vehicle. The first server apparatus 10 stores the history information to be correlated with identification information. The first server apparatus 10 continuously collects history information for each vehicle from being sold as a new car to being scrapped.

The first server apparatus 10 provides a vehicle chart of an assessment target vehicle to an assessor by using the history information accumulated in the above-described way. A flow of data at this time will be described below.

A purchase trader is allowed to acquire history information for assessment by a vehicle owner who desires to sell a vehicle, and then acquires identification information of the assessment target vehicle. The first terminal apparatus 20 of the purchase trader transmits assessment request information and the acquired identification information of the assessment target vehicle to the second server apparatus 14 of the assessor. The assessment request information includes an image of an exterior of the assessment target vehicle or the like. For example, the purchase trader inputs needed contents on a screen of an assessment system of the assessor, displayed on the first terminal apparatus 20, so as to make a request for assessment.

The second server apparatus 14 of the assessor acquires the assessment request information and the identification information, and transmits the acquired identification information to the first server apparatus 10.

The first server apparatus 10 acquires history information of the assessment target vehicle from a database based on the acquired identification information, and creates a vehicle chart based on the acquired history information. The first server apparatus 10 provides the created vehicle chart to the second server apparatus 14.

The vehicle chart includes, for example, driving habits of the past driver of the vehicle, evaluation of an engine, evaluation of a drive battery, a maintenance status, failure history, accident history, and whether or not the vehicle has been owned by a single owner. The driving habits indicate how an assessment target vehicle has been treated, and are information that is difficult to recognize from exterior check or inspection of the assessment target vehicle. Details of the vehicle chart will be described later.

The second server apparatus 14 of the assessor derives an assessment value based on the vehicle chart of the assessment target vehicle, and provides the derived assessment value to the first terminal apparatus 20 of the purchase trader.

For example, the second server apparatus 14 calculates a provisional assessment value based on a known technique by using a vehicle model, a model year, a traveling distance, an image of an exterior, and the like. Based on the vehicle chart, the second server apparatus 14 calculates an assessment value smaller than the provisional assessment value in a case where the driving habits are bad, and calculates an assessment value greater than the provisional assessment value in a case where the driving habits are good. An employee of the assessor may check the vehicle chart so as to calculate an assessment value.

The assessor can calculate a more appropriate assessment value based on the vehicle chart so as to provide the assessment value to the purchase trader. Since an assessment value is determined by also taking into consideration vehicle history in addition to an exterior of a vehicle, even in a case of a vehicle of which an assessment value is small due to an exterior such as a color thereof in assessment not using a vehicle chart, an assessment value thereof is likely to be great if vehicle history is favorable. The purchase trader has only to provide identification information to the assessor, and can thus easily acquire an assessment value. In a case where a user of a vehicle has good driving habits, there is a merit in which an assessment value thereof is likely to be great.

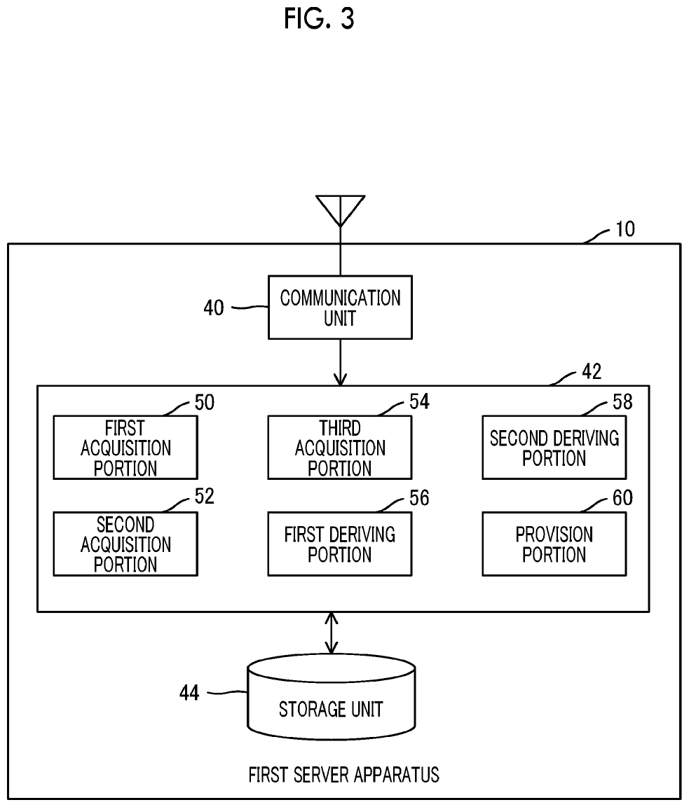

FIG. 3 is a block diagram illustrating a configuration of the first server apparatus 10 in FIG. 1. The first server apparatus 10 includes a communication unit 40, a processing unit 42, and a storage unit 44. The processing unit 42 includes a first acquisition portion 50, a second acquisition portion 52, a third acquisition portion 54, a first deriving portion 56, a second deriving portion 58, and a provision portion 60.

A configuration of the processing unit 42 is realized by a CPU and a memory of any computer, and other LSIs in terms of hardware, and is realized by a program loaded to a memory in terms of software, but, herein, a functional block realized cooperation therebetween is illustrated. Therefore, it is understood by a person skilled in the art that such a functional block can be realized in various forms by only hardware, only software, or a combination thereof.

The communication unit 40 performs communication with the on-vehicle devices 30, the second server apparatus 14, and the like. The communication unit 40 periodically receives pieces of history information of a plurality of vehicles from the on-vehicle devices 30, and outputs the received pieces of history information of the vehicles to the third acquisition portion 54.

The third acquisition portion 54 acquires the pieces of history information of the vehicles received from the communication unit 40, and stores the acquired pieces of history information of the vehicles to be correlated with respective pieces of identification information into the storage unit 44.

The first deriving portion 56 periodically derives statistical information regarding the pieces of history information of the vehicles for each vehicle model, and stores the derived statistical information into the storage unit 44. The statistical information includes, for example, an average value of evaluation values of respective characteristics such as torque and power of an engine, an average value of evaluation values of driving habits, an average value of fuel efficiency, and the greatest value of fuel efficiency.

The first deriving portion 56 may derive statistical information regarding each vehicle model every model year, and may derive statistical information regarding each model year every traveling distance division.

The communication unit 40 receives identification information of an assessment target vehicle from the second server apparatus 14, and outputs the received identification information to the first acquisition portion 50. The first acquisition portion 50 acquires the identification information of the assessment target vehicle received from the communication unit 40.

The second acquisition portion 52 acquires history information of the assessment target vehicle and statistical information regarding a vehicle model of the assessment target vehicle from the storage unit 44 based on the identification information acquired from the first acquisition portion 50.

The second deriving portion 58 derives a vehicle chart of the assessment target vehicle based on the identification information acquired by the first acquisition portion 50 and the history information and the statistical information acquired by the second acquisition portion 52. The vehicle chart includes first provision information and second provision information. The first provision information is information regarding the assessment target vehicle in the vehicle chart. The second provision information is information regarding a statistical value of the vehicle model of the assessment target vehicle in the vehicle chart.

The second deriving portion 58 derives the first provision information based on the identification information and the history information, and derives the second provision information based on the statistical information regarding the vehicle model of the assessment target vehicle.

The second deriving portion 58 specifies a vehicle model, a type, a model year, vehicle maintenance, and items of acquired vehicle information based on the acquired identification information. The second deriving portion 58 derives the first provision information based on the specified vehicle model, type, model year, vehicle maintenance, and items of the acquired vehicle information, and the history information. The first provision information includes, for example, a vehicle model, a type, a model year, vehicle equipment, a traveling distance, accident history, submersion history, recall non-response, evaluation of an engine, evaluation of a drive battery, fuel efficiency, a traveling frequency, a one-time traveling distance, driving habits of the past driver of a vehicle, warning lamp lighting history, and maintenance history. The vehicle equipment may include optional equipment, and may include a navigation system, a back guide monitor, safety equipment, and the like. The safety equipment may include, for example, an anti-lock brake system (ABS), a lane keeping assist (LKA), and an automatic brake.

For example, in a case of a vehicle that has been 15 years since the vehicle was sold as a new car, a period of vehicle information used to derive a vehicle chart may differ, such as a vehicle chart based on vehicle information for the latest 5 years or a vehicle chart based on vehicle information for the whole period of 15 years. Information for the whole period is preferably used for maintenance information, owner change information, and declaration information. In a case where a vehicle chart based on vehicle information for the latest predetermined period is derived, the processing unit 42 may delete vehicle information earlier than the predetermined period from the storage unit 44. Consequently, an amount of data to be stored can be reduced.

Periods of vehicle information to be used may be different from each other depending on information to be derived. For example, driving habits may be derived based on vehicle information for the whole period, and fuel efficiency may be derived based on vehicle information for a predetermined period such as the recent several months.

The provision portion 60 provides the first provision information and the second provision information derived by the second deriving portion 58 to the second server apparatus 14 of the assessor via the communication unit 40. The subsequent process in the second server apparatus 14 is as described above.

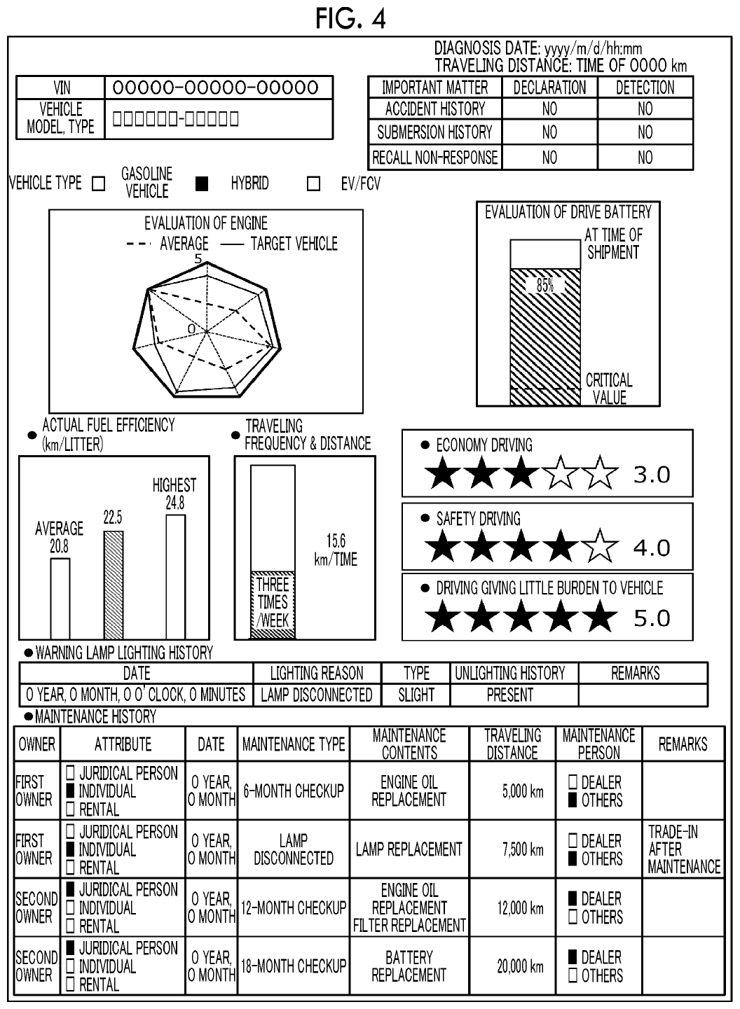

FIG. 4 illustrates a display example of a vehicle chart of a vehicle of which a vehicle type is a hybrid car, created by the first server apparatus 10 in FIG. 1. The vehicle chart includes a vehicle model, a traveling distance, accident history, submersion history, recall non-response, evaluation of an engine, evaluation of a drive battery, fuel efficiency, a traveling frequency, a one-time traveling distance, driving habits of the past driver of a vehicle, warning lamp lighting history, and maintenance history.

Each of the accident history, the submersion history, and the recall non-response includes the presence or absence of declaration made by the past owner of a vehicle, and the presence or absence of detection based on vehicle information or maintenance information. The second deriving portion 58 derives the presence or absence of declaration based on the declaration information. The second deriving portion 58 derives the presence or absence of detection of the accident history based on, for example, a change of acceleration in the vehicle information. The second deriving portion 58 derives the presence or absence of detection of the submersion history and the recall non-response based on the maintenance information.

The evaluation of the engine includes, for example, an evaluation value of a target vehicle and an average evaluation value with respect to respective items such as torque, power, a rotational speed, a response, quietness, and fuel efficiency. The second deriving portion 58 derives an evaluation value of the target vehicle based on various sensor values of the engine in the vehicle information. The average evaluation value is included in the second provision information, and indicates an average of evaluation values of a plurality of vehicles having the same vehicle model, the same model year, and the same traveling distance division as those of the assessment target vehicle. The evaluation of the engine will also be referred to as the degree of health of the engine.

The second server apparatus 14 can relatively recognize a state of the engine of the assessment target vehicle through comparison with the average of evaluation values of the vehicles having the same vehicle model, the same model year, and the same traveling distance division as those of the assessment target vehicle, and can thus easily calculate a more appropriate assessment value. The evaluation of the engine may include an evaluation value of a new car having the same vehicle model or the same type as that of the assessment target vehicle, and may compare an evaluation value of the assessment target vehicle with an evaluation value of the new car. The average evaluation value is an average of evaluation values of a plurality of unspecified vehicles, and can thus be compared with a highly accurate average also including the past vehicles not distributed on a used car market.

In a case where a vehicle model is a sports car, the number of items of evaluation of an engine may be larger than in a case where a vehicle model is a compact vehicle. In this case, it becomes easier to calculate a more appropriate assessment value through more detailed evaluation of an engine. In a vehicle model using an engine having relatively low performance, evaluation of the engine may be represented by a single evaluation value instead of being divided into various items. In this case, detailed evaluation of the engine hardly influences an assessment value. Consequently, it is easy to provide information desired to be known by an assessor.

The evaluation of a drive battery is indicated by a deterioration state in terms of numerical value. A smaller numerical value indicates that deterioration in the drive battery progresses. The second deriving portion 58 derives the evaluation of the drive battery based on various sensor values regarding the drive battery in the vehicle information. The evaluation of the drive battery will also be referred to as the degree of health of the drive battery.

The fuel efficiency includes fuel efficiency, average fuel efficiency, and the highest fuel efficiency of a target vehicle. The average fuel efficiency indicates an average of fuel efficiency of a plurality of vehicles having the same vehicle model and the same model year as those of the target vehicle. The highest fuel efficiency indicates the greatest value of fuel efficiency of the vehicles having the same vehicle model and the same model year as those of the target vehicle. The second deriving portion 58 derives the fuel efficiency based on a fuel consumption amount per unit time, an odometer value, or the like in the vehicle information.

The traveling frequency indicates an average number of times of traveling per predetermined period such as a week. The one-time traveling distance indicates an average traveling distance in one-time traveling. The second deriving portion 58 derives the traveling frequency and the one-time traveling distance by using the odometer value and the date-and-time information attached to the odometer value.

The driving habits include, for example, evaluation values for respective items such as “economy driving”, “safety driving”, and “driving giving little burden to a vehicle”. An evaluation value of the “economy driving” becomes smaller as fuel efficiency becomes lower, and becomes smaller as a period in which an economy mode is selected becomes shorter. An evaluation value of the “safety driving” becomes smaller as the number of operations of safety equipment such as an ABS becomes larger. An evaluation value of the “driving giving little burden to a vehicle” becomes smaller as the number of times of rapid acceleration, rapid steering, and rapid braking becomes larger. The second deriving portion 58 derives the driving habits based on the vehicle information. The assessor can understand how the assessment target vehicle treated in the past based on the driving habits, and thus the driving habits are likely to be one of effective determination materials for deciding a price.

Each item of the driving habits may include an average evaluation value of an identical vehicle model based on pieces of history information of a plurality of vehicles. For example, in a case of a sports car, compared with other vehicle models, an evaluation value of the “economy driving” may be small, but may be used as an effective determination material for deciding an assessment value through comparison with an average evaluation value of the “economy driving” of the same vehicle model. An average evaluation value of each item of the driving habits is also included in the second provision information.

The warning lamp lighting history includes the date and time of lighting, a lighting reason, a lighting type, and unlighting history, and may also be referred to as failure history. The second deriving portion 58 derives the warning lamp lighting history based on the vehicle diagnosis information. It is possible to calculate an assessment value by taking into consideration the past failure situations based on the warning lamp lighting history.

The maintenance history includes information indicating what number of a person is an owner of the vehicle at the time of maintenance, an attribute of the owner, the date of the maintenance, a maintenance type, a maintenance content, a traveling distance at the time of the maintenance, and information regarding a maintenance person. The second deriving portion 58 derives the maintenance history based on the maintenance information. It is possible to calculate an assessment value by taking into consideration whether or not the assessment target vehicle has been appropriately maintained on the basis of the maintenance history.

Although not illustrated, the vehicle chart may include information regarding the presence or absence of optional vehicle equipment.

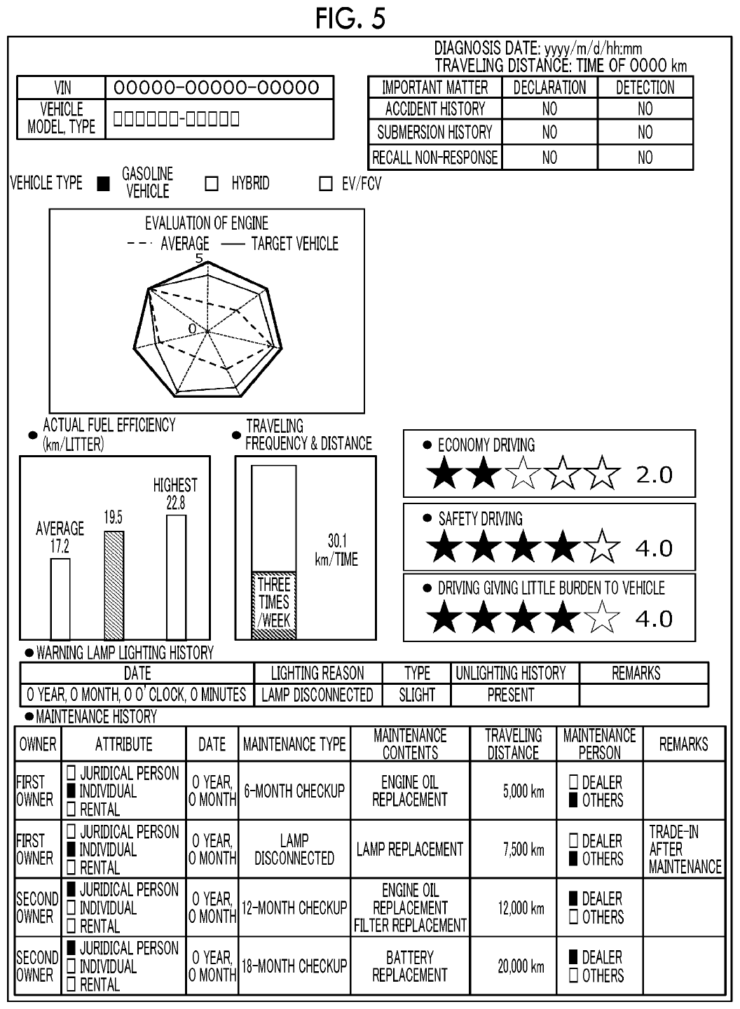

FIG. 5 is a diagram illustrating a display example of a vehicle chart of a vehicle of which a vehicle type is a gasoline car, created by the first server apparatus 10 in FIG. 1. This vehicle chart is different from the vehicle chart in FIG. 4 in that evaluation of a drive battery is not included. The vehicle chart may include evaluation of a lead battery used for ignition of an engine.

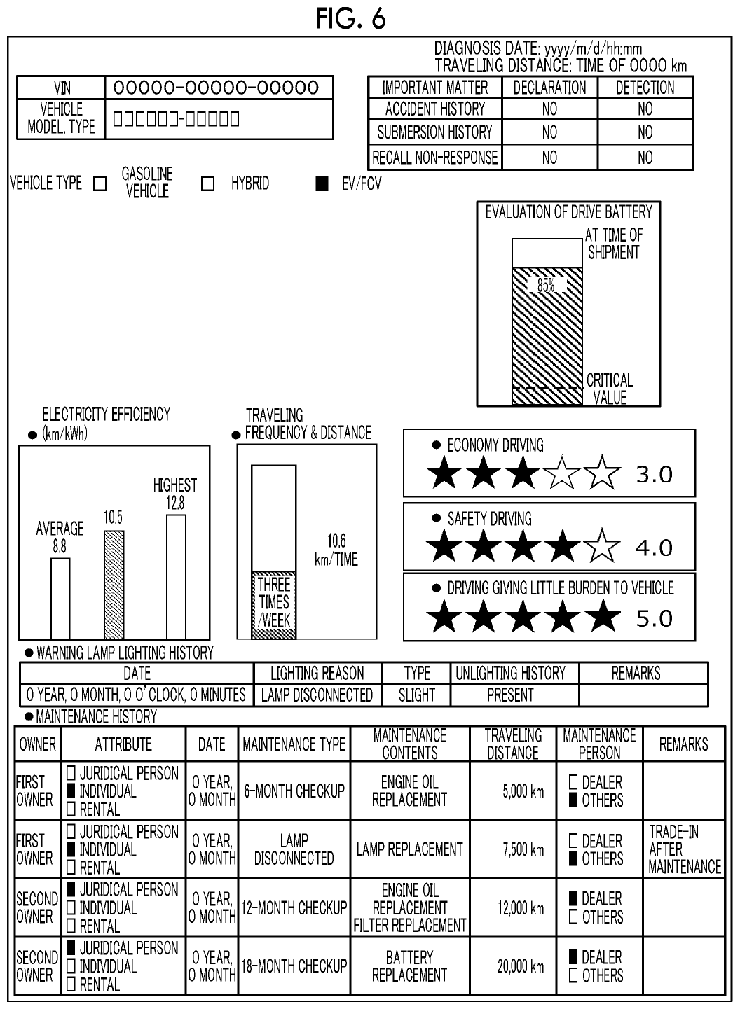

FIG. 6 is a diagram illustrating a display example of a vehicle chart of a vehicle of which a vehicle type is an electric vehicle (EV) or a fuel cell vehicle (FCV), created by the first server apparatus 10 in FIG. 1. This vehicle chart is different from the vehicle chart in FIG. 4 in that evaluation of an engine is not included, and electricity efficiency is included instead of fuel efficiency. The electricity efficiency indicates a traveling distance per unit electric power.

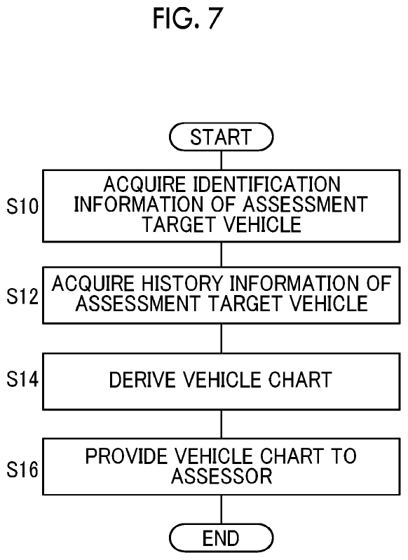

Next, the overall operation of the first server apparatus 10 having the configuration will be described. FIG. 7 is a flowchart illustrating a process in the first server apparatus 10 in FIG. 1. The process in FIG. 7 is performed when identification information of an assessment target vehicle is provided from the second server apparatus 14 of an assessor. The first server apparatus 10 acquires the identification information of the assessment target vehicle from the assessor (step S10), and acquires history information of the assessment target vehicle based on the acquired identification information (step S12). The first server apparatus 10 derives a vehicle chart based on the acquired history information (step S14), and provides the derived vehicle chart to the assessor (step S16).

According to the present embodiment, the second server apparatus 14 can derive a more appropriate price of an assessment target vehicle by using the first provision information based on history information of the assessment target vehicle and the second provision information based on statistical information regarding a vehicle model of the assessment target vehicle. Therefore, a purchase trader can acquire the more appropriate price of the assessment target vehicle.

### Second Embodiment

A second embodiment is different from the first embodiment in that evaluation of an engine, evaluation of a battery, or the like in a vehicle chart is created by also using maintenance information. Hereinafter, differences from the first embodiment will be focused.

The second deriving portion 58 derives the first provision information based on replacement date-and-time information and a preset replacement time of a part or an fluid in maintenance information of the assessment target vehicle with respect to the part or the fluid of which a replacement time recommended by an automobile maker is set. A replacement time is set for each part or fluid. A replacement time may be set for each vehicle model. Parts or fluids of which a replacement time is set may be, for example, an engine oil, an oil filter, a brake fluid, a spark plug, and a lead battery.

Replacement of an engine oil will be described as an example. A replacement time of the engine oil is a time arriving earlier of a year and traveling of 15,000 km. In the second embodiment, evaluation of an engine is represented by a single evaluation value. In a case where an engine oil is replaced by a replacement time, the second deriving portion 58 does not reduce a score in the evaluation of the engine. In a case where the engine oil is not replaced until the replacement time, the second deriving portion 58 reduces a score in the evaluation of the engine. The second deriving portion 58 may reduce a greater score in the evaluation of the engine as the number of times in which the engine oil is not replaced until the replacement time becomes larger. Consequently, it is possible to provide a vehicle chart in which whether or not a part or an fluid of which a recommended replacement time is set is replaced at an appropriate time is reflected.

The second deriving portion 58 derives the first provision information with respect to a preset part based on vehicle information after the replacement date and time related to a replaced part of a target vehicle. An example of the preset part may include a drive battery.

In a case where a drive battery is replaced, the second deriving portion 58 derives evaluation of the drive battery based on vehicle information after the replacement date and time related to a drive battery. This is because, in a case where the drive battery is replaced, vehicle information regarding the drive battery before being replaced is not related to evaluation of a drive battery after being replaced. Consequently, it is possible to provide accurate evaluation regarding a replaced part.

According to the present embodiment, it is possible to provide a highly accurate vehicle chart in which a maintenance status of a vehicle is reflected.

### Third Embodiment

A third embodiment is different from the first embodiment in that the first server apparatus 10 provides history information or the like before being converted into a form of a vehicle chart. Hereinafter, differences from the first embodiment will be focused.

The first deriving portion 56 performs a statistical process on pieces of vehicle information of a plurality of vehicles, so as to periodically derive statistical information regarding each vehicle model. The statistical information is derived for each item of vehicle information. The statistical information may include, for example, an average value of frequencies of a brake operation amount which is equal to or larger than a predetermined operation amount in a plurality of vehicles.

The second deriving portion 58 derives the first provision information including history information of an assessment target vehicle without deriving a vehicle chart, and derives the second provision information including statistical information regarding a vehicle model of the assessment target vehicle.

The second server apparatus 14 of an assessor derives an assessment value based on the first provision information and the second provision information provided from the first server apparatus 10. For example, the second server apparatus 14 may derive driving habits, evaluation of an engine, or the like related to the assessment target vehicle through a process similar to the process in the first server apparatus 10 of the first embodiment, and may derive an assessment value based thereon.

According to the present embodiment, it is possible to cope with an assessor needing history information or the like before being converted into a form of a vehicle chart.

### Fourth Embodiment

A fourth embodiment is different from the first embodiment in that the first server apparatus 10 periodically provides statistical information regarding each vehicle model to an assessor. Hereinafter, differences from the first embodiment will be focused.

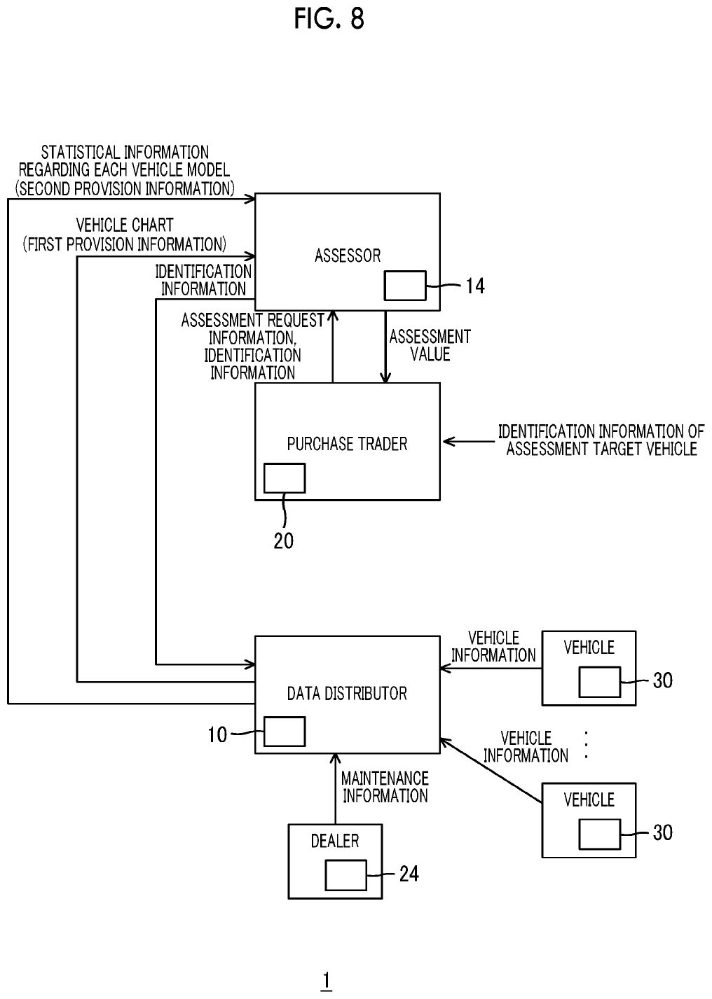

FIG. 8 illustrates a flow of data in the information processing system 1 according to the fourth embodiment. The provision portion 60 of the first server apparatus 10 periodically provides the second provision information based on statistical information regarding each vehicle model in pieces of history information of a plurality of vehicles, to the second server apparatus 14 of an assessor. The second provision information includes the same statistical information regarding each vehicle model as in the first embodiment. A frequency of providing the second provision information may be set as appropriate through a test or the like, and may be once a month.

In a case where identification information is acquired by the first acquisition portion 50, the second deriving portion 58 derives the first provision information based on the identification information and history information. In other words, the second deriving portion 58 derives a vehicle chart of an assessment target vehicle not including the second provision information. The provision portion 60 provides the first provision information derived by the second deriving portion 58 to the second server apparatus 14 of the assessor.

The second server apparatus 14 extracts statistical information regarding a vehicle model of the assessment target vehicle from the second provision information based on the identification information, and derives an assessment value based on the extracted statistical information and the first provision information.

According to the present embodiment, it is possible to improve the degree of freedom of a configuration of the first server apparatus 10.

### Fifth Embodiment

A fifth embodiment is different from the fourth embodiment in that the first server apparatus 10 provides history information or the like before being converted into a form of a vehicle chart. Hereinafter, differences from the fourth embodiment will be focused.

The first deriving portion 56 periodically derives statistical information regarding each vehicle model in the same manner as in the third embodiment. The provision portion 60 periodically provides the second provision information including the statistical information regarding each vehicle model to the second server apparatus 14 of an assessor.

In a case where identification information is acquired by the first acquisition portion 50, the second deriving portion 58 derives the first provision information including history information of an assessment target vehicle without deriving a vehicle chart.

According to the present embodiment, it is possible to cope with an assessor needing history information or the like before being converted into a form of a vehicle chart.

### Sixth Embodiment

A sixth embodiment is different from the first embodiment in that the first server apparatus 10 provides a vehicle chart to a purchase trader. Hereinafter, differences from the first embodiment will be focused.

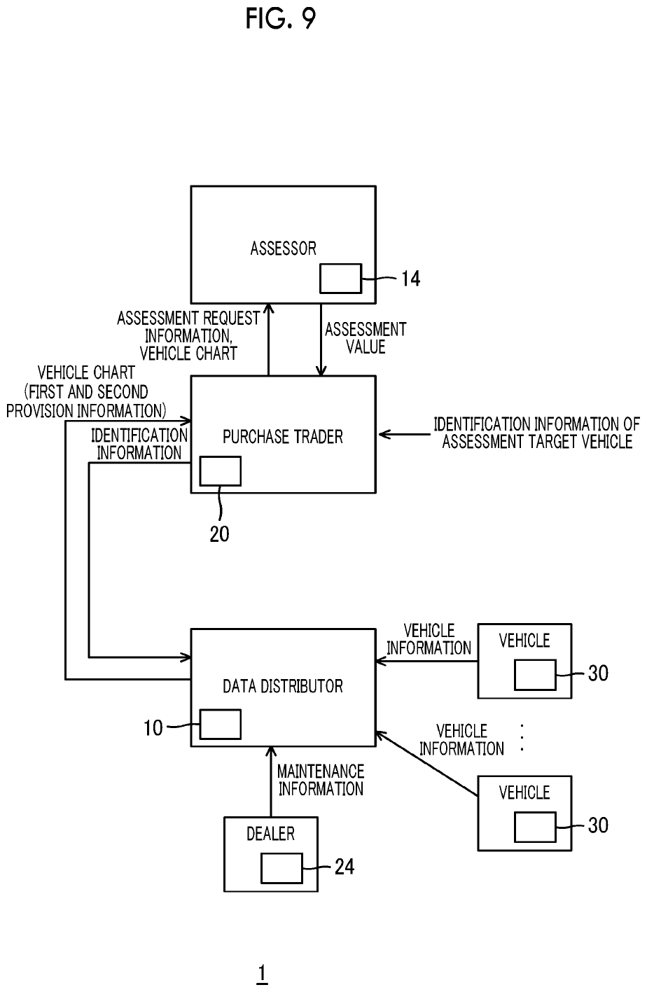

FIG. 9 illustrates a flow of data in the information processing system 1 according to the sixth embodiment. The first terminal apparatus 20 of a purchase trader transmits identification information of an assessment target vehicle acquired from a vehicle owner to the first server apparatus 10.

In the first server apparatus 10, in the same manner as in the first embodiment, the second acquisition portion 52 acquires history information or the like of the assessment target vehicle from the storage unit 44 based on the acquired identification information, and the second deriving portion 58 creates a vehicle chart of the assessment target vehicle based on the acquired history information or the like. The provision portion 60 provides the vehicle chart, that is, the first provision information and the second provision information derived by the second deriving portion 58 to the first terminal apparatus 20.

The first terminal apparatus 20 of the purchase trader deletes the identification information from the acquired vehicle chart of the assessment target vehicle, and transmits the vehicle chart not including the identification information and an assessment request information to the second server apparatus 14.

The second server apparatus 14 of the assessor derives an assessment value based on the assessment request information and the vehicle chart acquired from the purchase trader, and provides the derived assessment value to the first terminal apparatus 20 of the assessor.

According to the present embodiment, since a purchase trader acquires a vehicle chart, and acquires an assessment value by providing the acquired vehicle chart to the second server apparatus 14 of an assessor, it is not needed to provide identification information which is personal information enabling a vehicle to be specified to the assessor.

### Seventh Embodiment

A seventh embodiment is different from the sixth embodiment in that the first server apparatus 10 provides history information or the like before being converted into a form of a vehicle chart. Hereinafter, differences from the sixth embodiment will be focused.

The first deriving portion 56 derives statistical information regarding each vehicle model in the same manner as in the third embodiment. The second deriving portion 58 derives the first provision information including history information of an assessment target vehicle without deriving a vehicle chart, and derives the second provision information including statistical information regarding a vehicle model of the assessment target vehicle.

The second server apparatus 14 derives an assessment value in the same manner as in the third embodiment based on the first provision information and the second provision information provided from a purchase trader.

According to the present embodiment, it is possible to cope with an assessor needing history information or the like before being converted into a form of a vehicle chart.

### Eighth Embodiment

An eighth embodiment is different from the sixth embodiment in that the first server apparatus 10 periodically provides statistical information regarding each vehicle model to an assessor. Hereinafter, differences from the sixth embodiment will be focused.

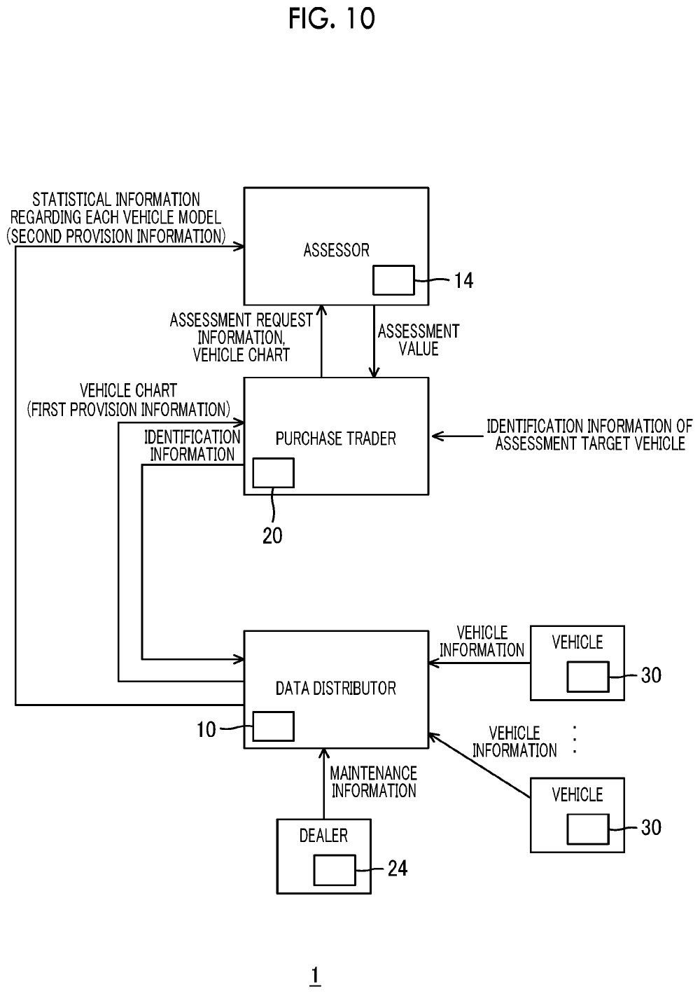

FIG. 10 illustrates a flow of data in the information processing system 1 according to the eighth embodiment. The provision portion 60 of the first server apparatus 10 periodically provides the second provision information including statistical information regarding each vehicle model to the second server apparatus 14 of an assessor in the same manner as in the fourth embodiment.

In a case where identification information is acquired by the first acquisition portion 50, the second deriving portion 58 derives the first provision information based on the identification information and history information. The provision portion 60 provides the first provision information derived by the second deriving portion 58 to the first terminal apparatus 20 of a purchase trader.

The second server apparatus 14 extracts statistical information regarding a vehicle model of the assessment target vehicle from the second provision information based on the identification information, and derives an assessment value based on the extracted statistical information and the first provision information provided from the purchase trader.

According to the present embodiment, it is possible to improve the degree of freedom of a configuration of the first server apparatus 10.

### Ninth Embodiment

A ninth embodiment is different from the eighth embodiment in that the first server apparatus 10 provides history information or the like before being converted into a form of a vehicle chart. Hereinafter, differences from the eighth embodiment will be focused.

The first deriving portion 56 derives statistical information regarding each vehicle model in the same manner as in the third embodiment. The provision portion 60 periodically provides the second provision information including the statistical information regarding each vehicle model to the second server apparatus 14 of an assessor.

In a case where identification information is acquired by the first acquisition portion 50, the second deriving portion 58 derives the first provision information including history information of an assessment target vehicle without deriving a vehicle chart.

According to the present embodiment, it is possible to cope with an assessor needing history information or the like before being converted into a form of a vehicle chart.

As mentioned above, the present disclosure has been described based on the embodiments. The embodiments are only examples, and it is understood to a person skilled in the art that various modifications may occur in combinations of respective constituent elements or respective processing processes, and the modifications are included in the scope of the present disclosure.

The second embodiment may be combined with each of the third to ninth embodiments. New embodiments occurring through the combinations achieve the respective effects of the combined embodiments.

In the embodiments, a description has been made of an example in which, in a case where identification information of an assessment target vehicle is acquired, the second deriving portion 58 derives a vehicle chart based on history information of the assessment target vehicle, but the second deriving portion 58 may periodically derive a vehicle chart in advance based on history information with respect to each of a plurality of vehicles. The second deriving portion 58 stores the derived vehicle chart of each vehicle to be correlated with identification information into the storage unit 44. The second acquisition portion 52 acquires a vehicle chart of an assessment target vehicle from the storage unit 44 based on identification information of the assessment target vehicle acquired from the first acquisition portion 50. The provision portion 60 provides the vehicle chart acquired by the second acquisition portion 52. In this modification example, it is possible to improve the degree of freedom of a configuration of the first server apparatus 10.

In the modification example, when a vehicle chart is derived, the provision portion 60 may provide the derived vehicle chart to the on-vehicle device 30 of the vehicle or a portable terminal of an owner of the vehicle. In the modification example, the owner of the vehicle can recognize current states of the vehicle.

The second deriving portion 58 may derive a vehicle chart without using statistical information. In this modification example, it is possible to simplify a process in the first server apparatus 10 and thus to reduce an amount of data to be stored. The first deriving portion 56 may derive statistical information regarding pieces of history information of a plurality of vehicles.

What is claimed is:

1. A server apparatus comprising circuitry configured to:
acquire identification information of an assessment target vehicle from an external server of an assessor;
acquire history information of the assessment target vehicle based on the identification information;
acquire pieces of history information of a plurality of vehicles;
derive statistical information on the pieces of history information for each of vehicle models; and
provide first provision information based on the history information of the assessment target vehicle and second provision information based on the statistical information regarding a vehicle model of the assessment target vehicle, to the external server.

2. The server apparatus according to claim 1, wherein
the circuitry is configured to periodically provide the second provision information based on the statistical information regarding each of the vehicle models to the external server.

3. The server apparatus according to claim 1, wherein
the circuitry is configured to periodically acquire the pieces of history information of the plurality of vehicles, and accumulate the history information for each of the plurality of vehicles.

4. The server apparatus according to claim 3, wherein
the circuitry is configured to derive the first provision information and the second provision information based on the pieces of history information of the plurality of vehicles acquired in a predetermined period.

5. The server apparatus according to claim 1, wherein
the statistical information includes at least one of an average evaluated value of engine torque, an average evaluated value of engine output, an average evaluated value of a driving tendency, an average of gas mileages, and an maximum gas mileage.

6. The server apparatus according to claim 1, wherein
the circuitry is configured to derive the statistical information for each of model years of each of the vehicle models.

7. The server apparatus according to claim 6, wherein
the circuitry is configured to derive the statistical information for each mileage range of each of the model years.

8. The server apparatus according to claim 1, wherein
the first provision information includes information on at least one of a driving tendency of a past driver, an engine evaluation, a traction battery evaluation, a maintenance condition, failure history, accident history, and the number of past owners.

9. The server apparatus according to claim 8, wherein
the driving tendency is calculated based on at least one of an evaluated value for eco-driving, an evaluated value for safe driving, and an evaluated value for vehicle-friendly driving, the evaluated value for the eco-driving being calculated based on at least one of a gas mileage of the assessment target vehicle and a length of an overall period during which an eco-mode is selected, the evaluated value for the safe driving being calculated based on the number of times a safety equipment mounted on the assessment target vehicle is activated, the evaluation value for the vehicle-friendly driving being calculated based on information relating to rapidity of acceleration, deceleration and steering of the assessment target vehicle.

10. The server apparatus according to claim 8, wherein
the second provision information includes an average evaluation value of the driving tendency calculated based on pieces of history information of a plurality of vehicles being a vehicle model which corresponds to the vehicle model of the assessment target vehicle.

11. An information providing method comprising:
(a) acquiring identification information of an assessment target vehicle from an external server of an assessor;
(b) acquiring history information of the assessment target vehicle based on the identification information;
(c) acquiring pieces of history information of a plurality of vehicles;
(d) deriving statistical information regarding the pieces of history information of the vehicles, for each of vehicle models; and
(e) providing first provision information based on the history information of the assessment target vehicle and second provision information based on the statistical information regarding a vehicle model of the assessment target vehicle, to the external server.

12. The information providing method according to claim 11, wherein
the step of (e) includes periodically providing the second provision information based on the statistical information regarding each of the vehicle models to the external server.

13. The information providing method according to claim 11, wherein
the step of (c) includes periodically acquiring the pieces of history information of the plurality of vehicles, and accumulating the history information for each of the plurality of vehicles.

14. The information providing method according to claim 13, wherein
the step of (e) includes deriving the first provision information and the second provision information based on the pieces of history information of the plurality of vehicles acquired in a predetermined period.

15. The information providing method according to claim 11, wherein
the statistical information includes at least one of an average evaluated value of engine torque, an average evaluated value of engine output, an average evaluated value of a driving tendency, an average of gas mileages, and an maximum gas mileage.

16. The information providing method according to claim 11, wherein
the step of (d) includes deriving the statistical information for each of model years of each of the vehicle models.

17. The information providing method according to claim 16, wherein
the step of (d) further includes deriving the statistical information for each mileage range of each of the model years.

18. The information providing method according to claim 11, wherein
the first provision information includes information on at least one of a driving tendency of a past driver, an engine evaluation, a traction battery evaluation, a maintenance condition, failure history, accident history, and the number of past owners.

19. The information providing method according to claim 18, wherein
the driving tendency is calculated based on at least one of an evaluated value for eco-driving, an evaluated value for safe driving, and an evaluated value for vehicle-friendly driving, the evaluated value for the eco-driving being calculated based on at least one of a gas mileage of the assessment target vehicle and a length of an overall period during which an eco-mode is selected, the evaluated value for the safe driving being calculated based on the number of times a safety equipment mounted on the assessment target vehicle is activated, the evaluation value for the vehicle-friendly driving being calculated based on information relating to rapidity of acceleration, deceleration and steering of the assessment target vehicle.

20. The information providing method according to claim 18, wherein
the second provision information includes an average evaluation value of the driving tendency calculated based on pieces of history information of a plurality of vehicles being a vehicle model which corresponds to the vehicle model of the assessment target vehicle.
